(19) United States
(12) Patent Application Publication
(10) Pub. No.: US 2020/0148985 A1
(43) Pub. Date: May 14, 2020

(54) Electronic Infusion Device

(71) Applicant: Eli Probst, Thousand Oaks, CA (US)

(72) Inventors: Eli Probst, Thousand Oaks, CA (US); Todd Metlen, Ojai, CA (US)

(21) Appl. No.: 15/986,576

(22) Filed: May 22, 2018

(51) Int. Cl. C12G 3/06; A23D 9/007; A23L 5/30; A47J 31/20

(52) U.S. Cl. CPC C12G 3/06; A23D 9/007; A23V 2002/00; A47J 31/20; A23L 5/32

(57) ABSTRACT

An apparatus for the efficient infusion on non-carbonated liquid substance with flavor from one or more non-liquid, food-grade infusive material. The apparatus may be used to infuse a variety of liquid materials such as alcohol or oil. The apparatus improves the efficiency of the infusion process with the specific and repeated application of ultrasonic frequencies over time.

### CROSS-REFERENCE TO RELATED APPLICATION

Not-applicable

### STATEMENT REGARDING FEDERALLY SPONSORED RESEARCH OR DEVELOPMENT

Not-applicable

### REFERENCE TO SEQUENCE LISTING, A TABLE, OR A COMPUTER PROGRAM LISTING COMPACT DISC APPENDIX

Not-applicable

### BACKGROUND OF INVENTION

### 1. Technical Field

The present invention relates generally to an electronic infusion device for the purpose of infusing non-carbonated liquid substances with the flavor of one or more non-liquid, food-grade infusive materials.

### 2. Prior Art

There are many infusion devices that do not include the novel improvements of the invention disclosed herein. The electronic infusion device of the invention provides improved performance, convenience, and efficiency.

It has been historically common practice to infuse liquid substances with the flavor of infusive materials, such as infusing water with the flavor of herbs and spices to create tea. This process has traditionally involved placing the infusive material into liquid and allowing the liquid to absorb flavor from the infusive material over a period of time. In some instances, heat or motion can be introduced to influence and/or promote the infusion process, such as with brewing coffee. But in all such cases, time is a critical component to the infusion process.

The time required to successfully infuse a liquid substances with flavoring from some infusive materials can be substantial and inconvenient. While tealeaves generally infuse quickly into water, particularly with the addition of heat, other material substances such as oak (commonly used to augment the flavor of wine and spirits), pears, cardamom seeds, and lemon grass can take many days to infuse. It is common practice to allow 1-2 weeks for infusive materials to successfully infuse most alcohol spirits. The present invention encompasses a method for using ultrasonic sound waves to substantially improve the efficiency of the infusion process, without the use of heat or mechanical motion, particularly for infusive materials that typically require days or weeks to infuse.

U.S. Pat. No. 7,213,507 issued to Glucksman et al discloses an infusion beverage system that requires a pre-heated liquid. U.S. Pat. No. 5,913,964 issued to Melton describes an infuser for making beverages, which requires a liquid to be introduced into the system at elevated temperatures. U.S. Pat. No. 7,240,610 issued to Wimmer et al discloses a method and apparatus for infusing a liquid with a flavoring or scent, which also requires a heat source. All of these prior art examples require the use of heat or elevated temperatures, which is not desirable for certain liquid substances such as alcohol. Additionally, any variance of temperature can effect the time required to successfully achieve a desirable result.

U.S. Pat. No. 6,915,733 issued to Langbauer describes a device and method for infusing that specifically involves the act of moving an infusive substance through liquid substance, which is preferably heated. In this prior art example, both mechanical motion and heat are required to achieve a desirable result.

When an ultrasonic wave (typically between 20 kHz-400 kHz) is introduced into a liquid substance, compression waves are formed that exert a separating force on the molecules to create microscopic voids or vacuum bubbles, which is called cavitation. There are a few existing devices that use ultrasonic cavitation.

U.S. Pat. No. 4,928,584 issued to Young describes an infuser using ultrasonic vibrations that requires a screen or mesh belt to pass an infusible solid material through a liquid substance. In this prior art example, it is necessary to mechanically move the infusive material through liquid substance.

Some current devices use cavitation to separate contaminants from material substrates. Ultrasonic cavitation is used to clean jewelry and other metal and plastic parts in both industrial and consumer products. Typically, the object to be cleaned is fully submersed into a liquid bath whereby ultrasonic waves are introduced to create cavitation bubbles in the liquid. This process is very effect in safely separating the contaminant particulates from material substrates and is a common method for cleaning certain materials.

Other devices use cavitation to extract gas bubbles from carbonated beverages. The forces created by ultrasonic pressure waves will purge gas, such as oxygen and carbon dioxide, from liquid. Some devices use short bursts of ultrasonic waves in carbonated beverages such as beer to intentionally extract small amounts of the gas trapped in the liquid, intended to enhance the drinking experience. In prior art GB1588624 issued to Hedderick et al, ultrasonic waves are introduced to a carbonated beverage to extract some portion of the gas absorbed in the liquid. While this may have a particular impact on the taste of carbonated beverages, this invention does not provide a method or device for successfully infusing the flavor of infusive materials into non-carbonated beverages using ultrasonic waves.

In all cases, it is important that liquid is used as a conduit for the sound waves between the transducer and any object that is not directly physically connected to the transducer. Even though designed to be flat, surfaces are rarely perfectly planar. The conduit liquid fills any gaps in conductivity between the surfaces to facilitate the efficient transference of acoustic waves. In the case of ultrasonic cleaning baths, the transducer is directly connected to a basin, which is then filled with liquid such that the material substrate is fully submersed in liquid. In the case of beverage devices that use ultrasonic cavitation, liquid such as water is placed between the beverage container and the basin connected to the transducer, acting as a conduit for the ultrasonic waves.

While the cavitation created by ultrasonic waves can effectively disrupt and separate the particulates from an infusive material inside liquid, the dispersion and diffusing of those particulates throughout the liquid can also be effected and manipulated by the compression forces of standing waves. Some devices move or circulate liquid by manipulating the forces of ultrasonic standing waves. U.S. Pat. No. 3,743,446 issued to Mandroian describes a specific system for utilizing pressure nodes and antinodes of standing acoustical waves to move water through a chamber. U.S. Pat. No. 6,079,214 issued to Bishop describes a standing wave pump that manipulates the movement of liquid through a chamber by using the standing wave forces created by two transducers. Although both of the above patents utilize standing waves to create movement in liquid, the intent is focused on pumping liquid through a chamber, not facilitating the effective distribution of particulates inside a container.

U.S. Pat. No. 4,879,011 issued to Schram discloses a process for controlling a reaction by ultrasonic standing waves. In the above prior art example, an ultrasonic standing wave is established and to support or retain a particulate medium inside a fluid medium and prevent the particulate from settling. The intent of this prior art example is to use ultrasonic pressure waves in essentially the opposite way as intended in the current invention.

### BRIEF SUMMARY OF INVENTION

It is the object of the present invention to provide a method for improving the efficiency and effectiveness of infusing non-carbonated liquid substances with the flavor of one or more infusive materials using ultrasonic waves.

The invention achieves the above objective by providing a comprehensive system for introducing ultrasonic waves into the non-carbonated liquid either intermittently and/or at a variable frequency. The cavitation bubbles created by ultrasonic waves disrupt the molecules of the infusive material inside the non-carbonated liquid. By intermittently applying those ultrasonic waves or by varying the frequency, disrupted particulates of the infusive material are prevented from becoming suspended or trapped in place by standing waves, but rather distributed as widely as possible throughout the non-carbonated liquid. This method creates both particulate disruption of the infusive material and facilitates particulate distribution, resulting in a much more efficient and efficacious way of infusing a non-carbonated liquid substance with infusive material(s) irrespective of the temperature of either the liquid substance or infusive material and without the need for mechanical motion.

### BRIEF DESCRIPTION OF THE DRAWING FIGURES

### Figures:

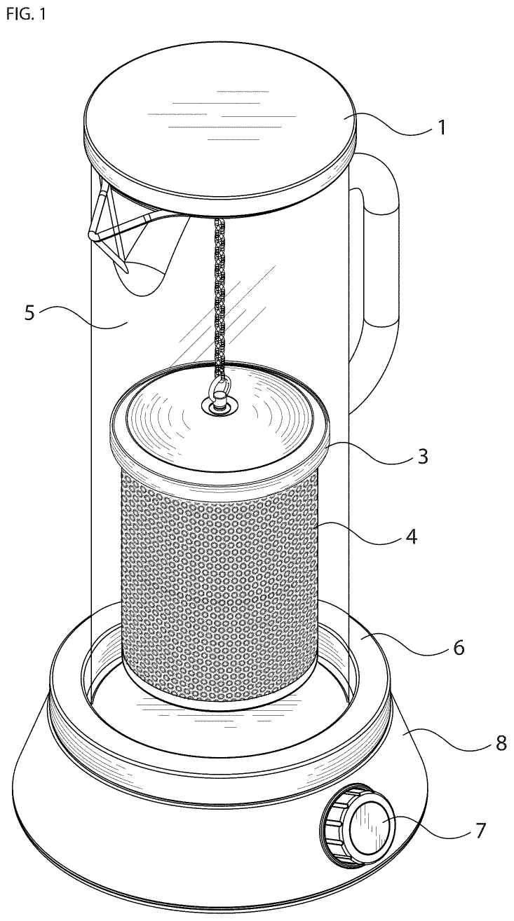

FIG. 1 is a perspective view of the electronic infusion apparatus;

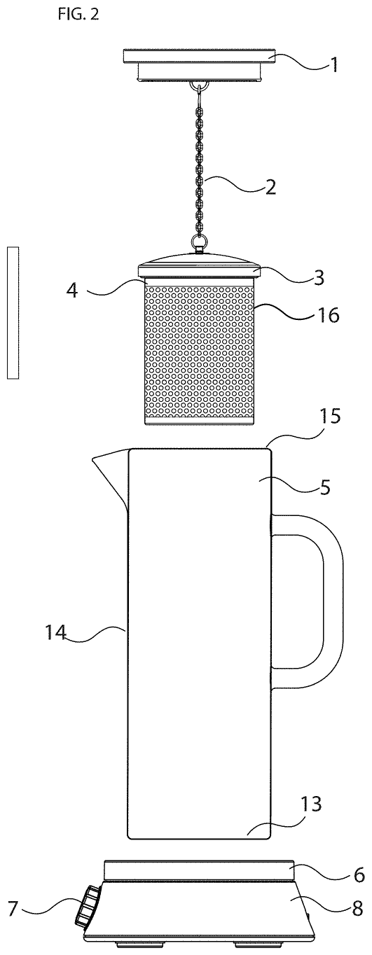

FIG. 2 is an exploded side view of the electronic infusion apparatus, showing the removable seal, infusion container, glass container, and a base, which houses the ultrasonic transducer and control circuit;

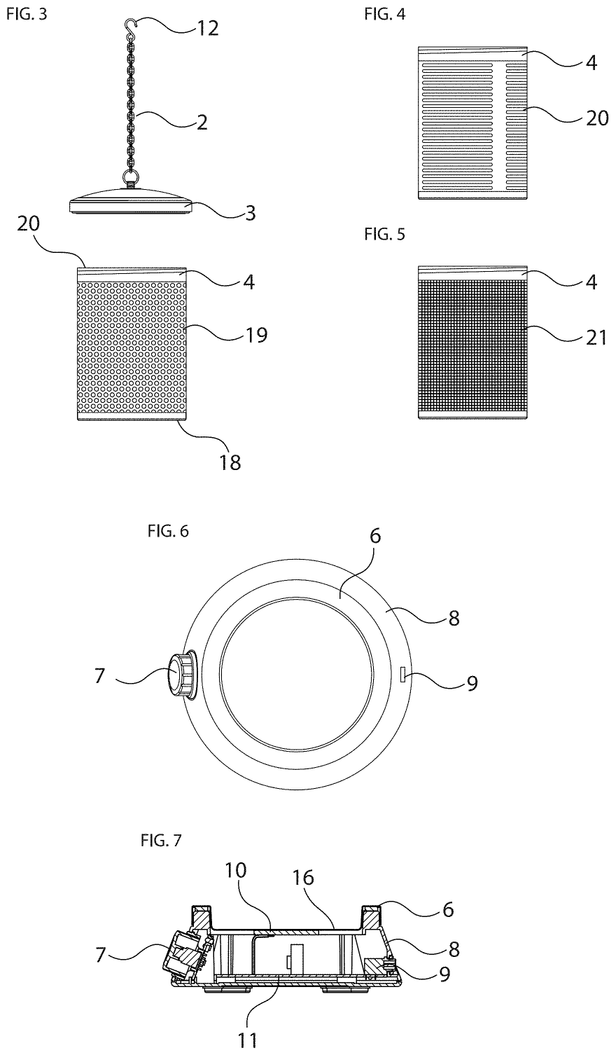

FIG. 3 is an exploded front view of the removable closure and infusion container for the infusive material having a plurality of fine perforations in the side wall;

FIG. 4 is a side view of the infusion container showing a permeable side wall having narrow slots;

FIG. 5 is a side view of the infusion container showing permeable side wall comprised of a fine mesh and or woven material;

FIG. 6 is a top view of the base of the electronic infusion apparatus;

FIG. 7 is a section view of the base showing the water basin, control circuit, switch, and ultrasonic transducer;

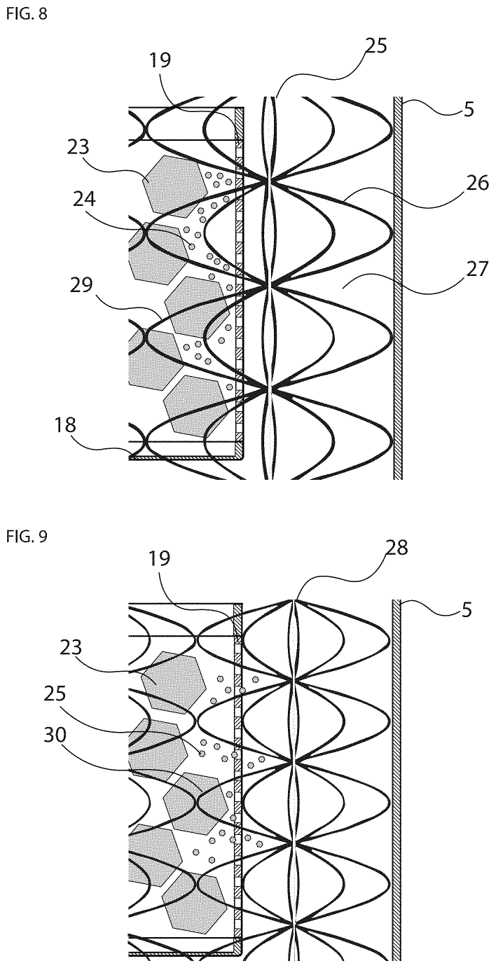

FIG. 8 is a partial section view showing the infusion container, infusive material, glass container, standing wave at a particular frequency, and the disrupted particulates of infusive materials suspended in place inside the infusion container by the ultrasonic pressure node;

FIG. 9 is a partial section view showing the infusion container, infusive material, glass container, standing wave at an alternate frequency, and the disrupted particulates of infusive materials now free to move through the permeable wall of infusion container unobstructed by the ultrasonic pressure node.

### DETAILED DESCRIPTION OF INVENTION

While it is understood that that the invention may be embodied in different forms, the following provides detailed description on the preferred embodiment.

Non-carbonated liquid substance is placed into the glass container 5 shown in FIGS. 1 and 2, which contains a solid bottom 13, solid sidewalls 14, and an open top end 15. The glass container is accordingly sized to contain a minimum of eight ounces of liquid.

Infusive materials are placed into the infusion container 4 best seen FIGS. 2-5, which includes a bottom 18, sidewall 16, and an open top 20. After the infusive material is inserted into the infusion container, the removable closure 3 is placed onto the container to completely enclose the infusive material.

The removable seal 1 shown in FIGS. 1 and 2 attaches to the open end 15 of the glass container 5, which helps to prevent outside contaminants from entering the glass container during the infusion process and helps to prevent the liquid material from spilling out of the container. The top of the removable closure 3 can be attached to the seal 1 by a chain 2 and hook 12 such that the infusion container 4 can be suspended in the non-carbonated liquid off the bottom of the glass container 13 when in operation. At least one surface of the infusion container 4 is porous allowing the non-carbonated liquid material to come into direct contact with the infusive material once full submersed into the glass container 5. Some examples of at least one porous side wall in the infusion container 4 are shown in FIG. 3-5, such as circular perforations 19, narrow slots 20, or mesh material 21.

The base 8 of the apparatus shown in FIG. 2-3, includes a basin 6 capable of holding at least one ounce of water, at least one switch 7, a power source or a connection 9 to an external power source, a control circuit 11, and an ultrasonic transducer 10 that is physically connected to bottom of the basin 16, which is best seen in FIG. 7.

The importance of applying ultrasonic waves intermittently and/or in varying frequencies to facilitate the even and random distribution of the disrupted particulates of infusive material throughout the liquid can be seen in FIG. 8-9. The standing wave 25 that is created in the glass container 5 when applying ultrasonic waves at a particular frequency is shown in in FIG. 8, whereby the pressure node 29 of the standing wave 28 has trapped the disrupted particulates 24 of the infusive material 23 behind the porous wall 19 of the infusion container, preventing even distribution and dispersion throughout the liquid in the glass container 5. By contrast, the standing wave 28 created by an alternate frequency is shown in FIG. 9, whereby the pressure node 30 of the standing wave 28 is not obstructing the disrupted particulates 25 of the infusive material 23, such that those disrupted particulates 25 can now pass freely through the porous wall 19 of the infusion container. By intermittently applying the ultrasonic waves or varying the frequency, breaks or changes in the pressure nodes are created that allow the disrupted particulates of infusive material to diffuse and distribute throughout the non-carbonated liquid.

To maximize efficacy of the apparatus, a small amount of water is placed into the basin 6 on the base 8, which serves as a conduit for the transmission of sound waves between the ultrasonic transducer 10 connected to the bottom of the basin 16, and the glass container 5 housing the non-carbonated liquid and infusive material(s). The user controls the infusion process with the switch 7 that is electrically connected to the control circuit 11 housed inside the base 8. When the infusion process is complete, the user can cleanly and easily remove the infusive material from the non-carbonated liquid by simply removing the infusion container 4 from the glass container 5. The resulting infused non-carbonated liquid may be stored and served from the glass container 5.

The invention claimed is:

1. An electronic infusion apparatus for infusing a non-carbonated liquid substance with flavor of one more non-liquid food-grade infusive material and is comprised of:
a power source; and
a glass container for holding a minimum of 8 fluid ounces of liquid that has one open end; and
a removable seal that attaches to the open end of said glass container; and
an infusion container for one more non-liquid infusive material(s), which fits inside said glass container, and that also includes a removable closure for the top of the infusion container and at least one porous surface; and
a base that includes a control circuit operatively connected to said power source, at least one switch, a basin capable of holding at lease once ounce of liquid, and an ultrasonic transducer that is operatively connected to the control circuit and physically connected to the basin; wherein
the control circuit delivers an electrical signal to the ultrasonic transducer, which causes the transducer to oscillate at a frequency between 1900 MHz to 10000 MHz, on an intermittent basis with at least one active period of oscillation and at least one period of rest without oscillation, for which the active oscillation period(s) and rest period(s) individually range from 0.5-600 seconds in duration.

2. The electronic infusion apparatus in claim 1 wherein the oscillation frequency is varied over time in a predetermined cycle during the active period of oscillation.

3. The electronic infusion apparatus in claim 1 wherein the power source is a removable and/or replaceable battery.

4. The electronic infusion apparatus in claim 1 wherein the non-carbonated liquid substance is an alcohol spirit.

5. The electronic infusion apparatus in claim 1 wherein the non-carbonated liquid substance is a cooking oil.

6. The electronic infusion apparatus in claim 1 wherein the duration of the intermittent operation of the ultrasonic transducer is user selectable.

7. The electronic infusion apparatus in claim 1 wherein the porous surface(s) of the infusion container may be comprised of one or more mesh or woven materials.

8. The electronic infusion apparatus in claim 1 wherein the porous surface(s) of the infusion container may be a perforated.
